(19) United States
(12) Patent Application Publication
(10) Pub. No.: US 2025/0259200 A1
(43) Pub. Date: Aug. 14, 2025

(54) IN STORE AR REWARD EXPERIENCE ADVERTISING

(71) Applicant: Benjamin Capital Partners, Inc., New York, NY (US)

(72) Inventors: Jason Bender, Bee Cave, TX (US); Aubrey Kristopher Johnson, Bee Cave, TX (US)

(21) Appl. No.: 19/070,087

(22) Filed: Mar. 4, 2025

Related U.S. Application Data
(63) Continuation of application No. 18/975,637, filed on Dec. 10, 2024.
(60) Provisional application No. 63/609,763, filed on Dec. 13, 2023.
(60) Provisional application No. 63/561,703, filed on Mar. 5, 2024.
(60) Provisional application No. 63/561,703, filed on Mar. 5, 2024.

(51) Int. Cl. G06Q 30/0217; G06T 19/00

(52) U.S. Cl. CPC G06Q 30/0217; G06T 19/006

(57) ABSTRACT

An Event Triggered Augmented Reality (AR) Reward Experience is provided comprising an AR enabled device (cell phones, tablets, smart watches, vision goggles, etc.) for receiving a triggered reward experience from a source thereof, and for allowing an end user to locate a selected object within a viewing screen of the AR enabled device. When the selected object is located, the AR enabled device indicates a designated reward for the user. The triggered reward experience may come when the end user begins the AR Reward Experience, or alternatively, upon completion of a commercial transaction, for which An AR Reward Experience has been created.

### CROSS REFERENCE TO RELATED APPLICATION(S)

This application claims priority to U.S. Non Provisional application Ser. No. 18/975,637 filed Dec. 10, 2024, which claimed priority to U.S. Provisional Application, Ser. No. 63/609,763, filed Dec. 13, 2023, and to U.S. Provisional Application, Ser. No. 63/561,703, filed Mar. 5, 2024. This application also claims priority to U.S. Provisional Application, Ser. No. 63/561,703, filed Mar. 5, 2024.

This application is also being filed on the same day as the following applications, which are related: U.S. Non Provisional application Ser. No. ______ (Docket NT.00003) entitled “EVENT TRIGGERED AR REWARD EXPERIENCE”; U.S. Non Provisional application Ser. No. ______ (Docket NT.00004) entitled “SHARED AR REWARD EXPERIENCE”; U.S. Non Provisional application Ser. No. ______ (Docket NT.00005) entitled “SHAREABLE VIDEO OF AR REWARD EXPERIENCE”; U.S. Non Provisional application Ser. No. ______ (Docket NT.00006) entitled “MERCHANT SELECTABLE OBJECTS WITHIN AN AR REWARD EXPERIENCE”; U.S. Non Provisional application Ser. No. ______ (Docket NT.00007) entitled “IN STORE AR REWARD EXPERIENCE ADVERTISING”; and U.S. Non Provisional application Ser. No. ______ (Docket NT.00008) entitled “GEO FENCE INITIATED AR REWARD EXPERIENCE”.

### BACKGROUND

### Field of the Invention

The invention described herein relates generally to the use of mobile electronic devices such as cell phones, tablets, headsets, watches, etc. utilizing augmented reality (AR) for the purpose of attracting and rewarding customers that engage in AR activities.

### Background of the Invention

Augmented reality (AR) is an interactive experience that enhances the real world with computer-generated perceptual information. Utilizing software, applications, and hardware such as AR glasses, AR overlays digital content onto real-life environments and objects. This augmentation enhances the user experience and transforms one's immediate surroundings into an interactive learning environment. Augmented Reality works by superimposing digital information onto real-world objects to create a 3D experience that allows users to interact with both the physical and digital worlds.

If you have ever utilized a street view service (e.g., Apple Maps, Google Maps, etc.) to familiarize yourself with a neighborhood prior to travel or an interior decoration application to visualize furniture placement in your living room, you have already encountered augmented reality (AR). In the entertainment industry, there are numerous examples of AR: filters that modify the visual appearance of an individual within a photograph, games that integrate real and virtual environments, and applications that position virtual characters within a physical setting.

In the current digital marketing ecosystem, engagement and retention strategies are facing significant challenges. Traditional methods, such as email, texting, and standard in-app notifications, are becoming increasingly ineffective. These methods are characterized by their repetitive and overused nature, and thus are failing to capture the attention of the target audience. Emerging technologies such as augmented reality (AR) have the potential to help marketers differentiate their campaigns, yet they remain underutilized due to high costs and technical complexity. Most AR marketing is one-time, high-cost initiatives delivering visually appealing but ephemeral campaigns focused primarily on brand awareness. These campaigns fail to offer tangible value or incentives to the end customer and thus do not contribute significantly to customer engagement or long-term brand loyalty.

This absence of customer-centric, engaging, and value-driven marketing experiences results in missed chances to establish stronger connections with consumers, which can, in turn, effectively impact consumer behavior. Addressing these challenges, our invention introduces a novel system which integrates AR into marketing strategies by providing an ‘experience as a service’. This enables marketers to engage with their audience by offering rewards (such as cash, points or even physical items) within an AR environment. Our AR reward system creates a more immersive and interactive experience for consumers, leading to better engagement and higher marketing efficiency. Our system further increases the yield of marketing spend by driving higher Return on Ad Spend (ROAS) over traditional, less engaging, mediums like social ads or email. Our invention further offers significant flexibility, empowering marketers to trigger an AR experience at any point in the customer lifecycle.

This flexibility allows marketers to tailor our AR system for specific marketing objectives, whether it be driving engagement, retention, lift, frequency, dayparting, or other specific consumer behaviors. In addition, our system provides a turnkey setup that allows marketers to create and deploy AR reward campaigns through a point-and-click interface. Our system reduces the technical and financial barriers associated with AR, making it accessible to a wider range of marketers, including those with limited resources. Deploying a campaign can be done with a low effort code integration or, in the case of some campaigns, without any integration at all.

There is currently nothing in the market that is purpose built for enabling a reward experience in AR. Furthermore, there is not anything that enables an AR experience to be configured, composed and deployed in a turn key manner, via a web interface.

### SUMMARY OF THE INVENTION

In one embodiment, the present invention provides an Augmented Reality (AR) Reward Experience system that includes an AR enabled device, a Decision Maker System, in communication with the AR enabled device, the Decision Maker System configured to create a Reward Campaign for at least one AR enabled device, an AR Trigger, in communication with the AR enabled device, for initiating an AR Reward Experience after the Reward Campaign is created, and A Reward Platform, in communication with the Decision Maker System and the AR enabled device, for communicating a Reward to the AR enabled device, wherein the AR Reward Experience system provides an engaging augmented reality for allowing a user to find and locate a virtual object using their AR enabled device, for the purpose of earning a reward.

In an alternative embodiment, the present invention provides a Marketplace system for triggering an AR enabled device, including an AR Trigger, for triggering an AR enabled device after and end user of the AR enabled device completes a commercial transaction, the AR enabled device, for receiving the trigger, and software, executing on the AR enabled device, for launching an AR Reward Experience, wherein the software provides a thru view of the world in front of the AR enabled device, presents a selected object to the end user when the AR enabled device is pointed at a preselected virtual position relative to the end user, and presents a Reward to the end user when the end user locates the selected object within the thru view, wherein the end user is engaged in the AR Reward Experience after completing the commercial transaction.

In another embodiment, the present invention provides a marketing method for engaging a user in a marketing campaign, the marketing campaign utilizing an Augmented Reality (AR) system, the method including creating a marketing campaign within the AR system, defining a set of rewards within the marketing campaign, the rewards selected for users that complete the marketing campaign; initiating an AR Reward Experience, and upon completion of the AR Reward Experience, awarding a reward from the set of rewards to a user that completes the marketing campaign, wherein the marketing campaign engages the user utilizing the AR system, thereby creating an effective marketing campaign.

In yet another embodiment, the present invention provides an Augmented Reality (AR) Reward Experience system, the system including An AR enabled device, A Decision Maker System, in communication with the AR enabled device, the Decision Maker System configured to create a Reward Campaign for at least one AR enabled device; and A Reward Platform, in communication with the Decision Maker System and the AR enabled device, for communicating a Reward to the AR enabled device, wherein the AR Reward Experience system provides an engaging augmented reality for allowing a user to recognize a virtual object overlayed in a physical location using their AR enabled device, for the purpose of earning a monetary reward.

In yet another embodiment, the present invention provides An Event Triggered Augmented Reality (AR) Reward Experience system, including: an AR device; an AR Event Trigger, in communication with the AR device, for initiating an AR Reward Experience; and a Reward system, in communication with the AR device, for communicating a Reward to the AR device; wherein the AR Reward Experience system provides an engaging augmented reality for allowing a user to recognize a virtual object using their AR enabled device, for the purpose of earning a reward; and wherein the AR Reward Experience is initiated by an AR Event Trigger.

### BRIEF DESCRIPTION OF THE DRAWINGS

FIG. 1 is a block diagram of an AR Reward Experience system and method.

FIG. 2 is an illustration of an AR enabled device showing an initiation to the AR Reward Experience.

FIG. 3 is an illustration of the AR enabled device showing a permissions screen, if needed.

FIG. 4 is an illustration of the AR enabled device showing a pass-thru environment, on the devices screen.

FIG. 5 is an illustration of the AR enabled device showing the pass-thru environment, as well as an object to be found overlay.

FIG. 6 is an illustration of the AR enabled device showing the Reward won by a user after locating the object to be found.

FIG. 7 is an illustration of the AR enabled device showing the rewards that have been won by the user within the AR experience.

FIG. 8 is a flow chart illustrating the flow of the AR Reward Experience for a particular marketing campaign.

FIG. 9 is an illustration depicting the workflow for a post-transaction triggered AR Reward Experience.

FIG. 10 is an illustration depicting the function of how random object positioning occurs relative to the AR enabled device.

FIG. 11 is an illustration of how geo specific object positioning relative to the AR enabled device functions.

FIG. 12 is an illustration of how event triggers initiate rewarding a user based on events.

FIG. 13 is a pictorial illustration of a coffee shop with patrons utilizing the augmented reality (AR) reward experience according to the present invention.

FIG. 14 is a flow chart illustrating program flow of the AR Reward experience within a group competition.

FIG. 15 is a pictorial illustration of the coffee shop of FIG. 13 where the patrons are using a group AR Reward Experience according to the present invention.

FIG. 16 is a block diagram of an AR Reward Experience system and method according to the present invention including Shared AR control, Recording and playback control, and a Library of AR objects.

FIG. 17 is an illustration of a retail merchant advertising using a digital display.

FIG. 18 is an illustration of an AR reward experience utilizing the digital display advertising of FIG. 17.

FIG. 19 is an illustration of an AR Reward resulting from engaging in the AR reward experience of FIG. 18.

FIG. 20 is an illustration of the AR reward experience of the present invention using geo fence technology to create event triggers on devices capable of being AR enabled.

### DETAILED DESCRIPTION

Our invention is an augmented reality (AR) experience that can be customized, themed, and deployed for a given brand. The augmented reality experience is a discovery game where an end user examines their environment for a given item(s) (object-to-find) using a AR enabled device (currently through the camera of a mobile phone but also an AR headset as well). Upon recognizing the item they have been tasked to recognize, the end-user engages with the object-to-find by tapping on it through their phone screen (or looking at it through a headset). Each experience has 1 to n items that must be recognized (or identified). When all have been recognized, the end user is presented with a reward.

The object-to-find that the end-user must recognize is a 3d model or series of 3d models that can be either static or animated. The experience can be bound to a specific location, or a location that is relative to the end user. For example, if a coffee shop wanted their customers to only be able to engage with, and complete, the experience inside one of their physical store locations, the experience can be restricted to only work on-site. This is done using geographical coordinates and employing an appropriately sized geo-fence around the coordinate, designating the area in which the experience can operate. In one aspect of the invention, an AR object is provided that when recognized, produces monetary rewards tied to a specific physical location.

The object-to-find in AR space can be in a random position relative to the user operating the AR enabled device, it can be fixed to a specific location, or it can be in a location that is relative to a geo coordinate. Let's look at these cases individually:

**Random position:** when the end-user opens the AR experience, the invention makes a real-time decision about where to position the object-to-find. The object is configured at a set distance from the AR enabled device. The distance is a determination made ahead of time and is specifically chosen to make sure the object is at an appropriate size and is easily discoverable. The position of the object is then determined by moving the object a randomly determined number of degrees around a 360 degree arc using the AR enabled device as the center and the fixed distance as the radius. When positioning the object, exclusion zones may be pre-configured. An exclusion zone is a field-of-view (FOV) exclusion where the object will not show (e.g. don't show the object directly in front of the end-user when the experience is activated).

**Specific location:** in this configuration, the object-to-find is positioned at a specific geo-coordinate. In order to find and interact with the object, the end-user must be in the same physical location as the object. An example of this use case may be a large event (like SXSW or Coachella) where a brand might challenge end-users to find and collect a set number of objects throughout the event space in order to receive a specific reward. The AR enabled device must also be geo-location enabled such that the device location can be determined relevant to the object-to-find.

“Relative to a geo coordinate”—In this configuration, the object-to-find may be in a brick and mortar structure, or an otherwise geo specific area (e.g., a store, an outdoor tent area, etc.), but rather than utilizing GPS, the area may utilize Near Field Communications (NFC), WiFi triangulation technology, or physical positioning beacons within the area. That is, in one embodiment, the object-to-find may ‘hover’ over an area defined by the AR experience, once the end user enters the geo specific area. It should be appreciated by one skilled in the art that the methodology used to overlay the virtual object to find, within a physical space, should not be limited to existing communication protocols described herein, but should extend to emerging technologies for placement of virtual objects in a physical space. How the object is randomly positioned in proximity to the user in this use case isn't as critical as the idea that there is an object placed in a physical location that the user visits. When the user finds/sees that object, they receive a monetary reward.

The reward associated with the object-to-find is monetary, i.e., a discount, a promotion, a coupon, a physical item, a gift-card, or cash back. Depending on the campaign configuration, the reward can be either fixed or variable. In the fixed case, every end-user that engages with the associated AR campaign is going to find/receive the same reward. In the variable case, what the end-user receives can vary (e.g. every end-user at least finds a free donut but 1 end-user will receive a $5k grand Reward). Virtual items with a real world monetary value is a novel concept.

Configuring an AR campaign is done through a web-based campaign builder tool. In this tool, a marketer can build, customize, configure, and deploy an AR reward campaign using a point-and-click interface. Depending on the configuration, it is possible for a marketer to setup and launch a campaign without having to coordinate with engineering staff to build any functionality or do a code level integration. In other configurations, light code integration is required. That code integration is intentionally structured to require minimal lift from integrating partners.

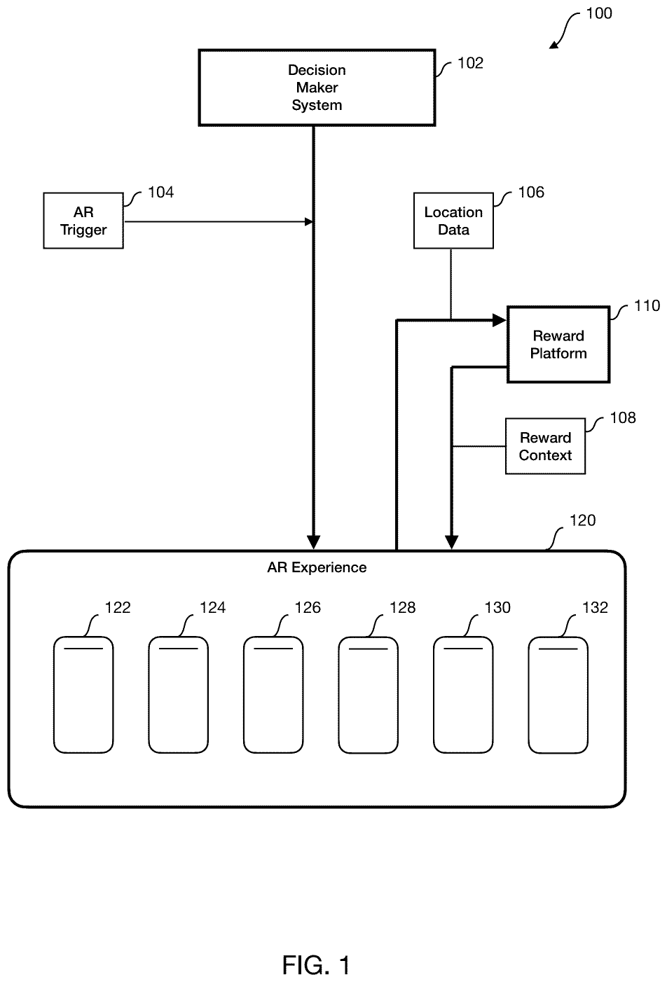

Referring to FIG. 1, a system diagram 100 is provided illustrating an end to end augmented reality (AR) reward experience. The experience starts with a decision maker system 102 determining that an end user should receive an AR rewards experience. The decision maker could be a company, an individual, or a piece of software. The decision-maker not only determines who will get the experience and win, it also determines which experience (campaign) the end user will be receiving. The decision maker system 102 can be a computer, a tablet, a phone, etc., in combination with the AR reward software further described below. In one embodiment, the decision maker system 102 includes a web hosted server, and software for configuring campaigns for the AR experience system.

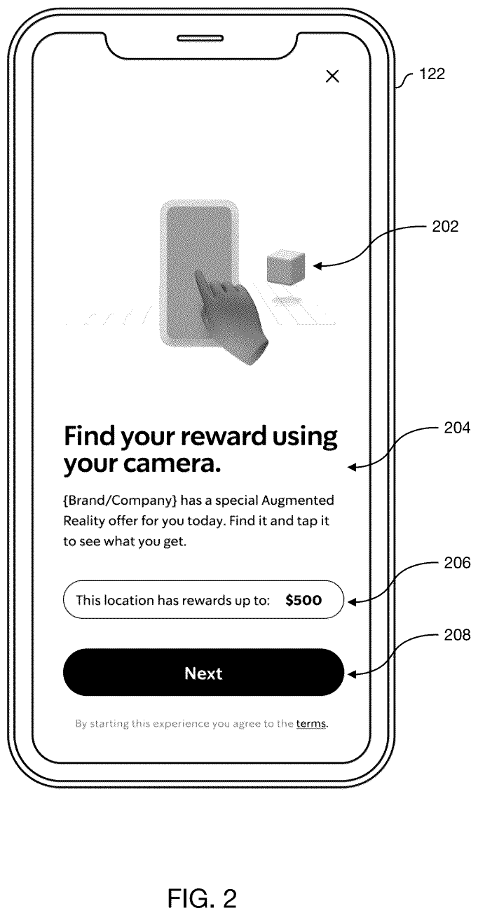

An AR Trigger 104 is shown coupled to the Decision Maker System 102 for sending an AR Trigger to an AR Experience 120. The AR Experience 120 includes one or more user devices 122-132. For purposes of FIG. 1, the AR Experience 120 is illustrated with a single device 122, that has multiple states during the AR Experience, as will be further described below with reference to FIGS. 2-7. The AR Trigger 104 is a signal sent from the decision maker system 102 to an AR enabled device 122 notifying the device of the eligibility to participate in the AR Experience 120. In one embodiment, the AR Trigger 104 is an instruction sent to an AR enabled device 122 over a telecommunications network. Alternatively, the instruction may be sent to an AR enabled device via a wifi network.

In one embodiment, the user device 122 that runs the AR experience is a smart phone, a tablet, a headset, or other AR enabled hardware. In the case of geo restricted or geo activated campaigns, the AR enabled device 122 communicates geo location data 106 to a reward platform 110 to confirm eligibility for the respective campaign. The Reward Platform 110 contains the knowledge and configuration information for the campaign that is being triggered. The Reward Platform 110 looks up the campaign, confirms eligibility, and makes a real-time decision about the reward that will be awarded for this instance of the AR Experience. The Reward Platform further communicates the reward information back to the AR enabled device 122.

A Reward Context 108 contains confirmation of eligibility. If eligible, it also contains the needed information to execute the experience on the AR enabled device 122. That information includes: theming context (i.e., how the experience should look for this campaign), 3D model to be used, and reward determination (what reward is the end user going to be looking for).

After receiving the reward context, the AR enabled device 122 presents a prompt to begin the reward.

Referring to FIG. 2, the AR enabled device 122 is shown. As mentioned above, the AR enabled device 122 could be a smart phone, a tablet, a headset, or other AR enabled hardware. More specifically, the AR enabled device 122 has received an AR Trigger 104 signal. The screen in FIG. 2 shows context on how to participate and also covers needed device permissions if applicable (e.g., camera and location). In one embodiment, an illustration of the object to be found is shown as object 202 on the screen of the AR enabled device 122. And, in addition to providing a visual illustration of an object 202, help text 204 may also be provided to inform the user of how to participate in the AR Experience. Alternatively, a visual tutorial 202 can be shown illustrating how the end user will participate and complete the AR experience. Furthermore, an indication of a Reward 206 is shown to encourage the user to continue with the AR experience. Finally, a Next button 208 is provided to advance the user to the next step in the AR experience. What should be appreciated by one skilled in the art is the concept of putting a virtual object in augmented space that, when interacted with, provides the user a monetary reward. The exact implementation of this idea may be accomplished in a variety of ways, without departing from the scope of the invention.

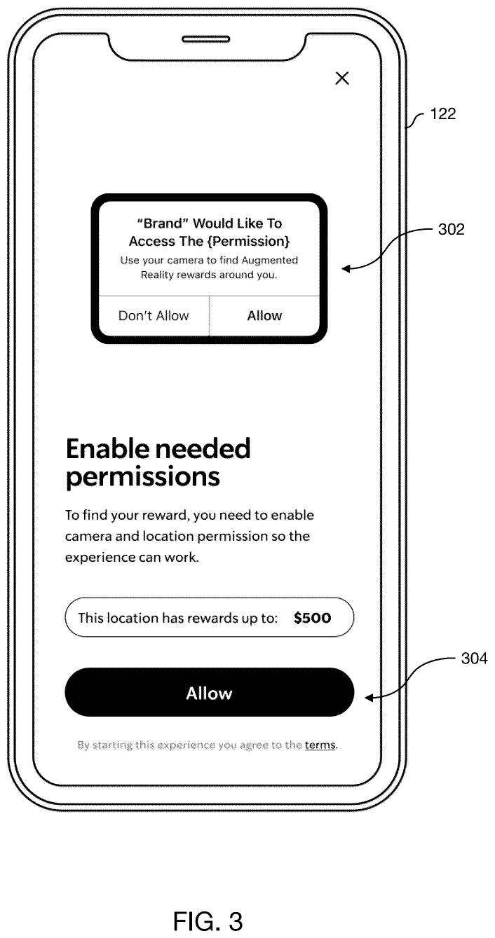

Referring to FIG. 3, the AR enabled device 122 is shown. The screen on the AR enabled device 122 follows after selection of the Next button 208 from FIG. 2. More specifically, if the AR enabled device 122 has not yet had an AR experience, a permissions dialogue box 302 is provided. The box allows the user to either Allow, or Don't Allow, the AR experience that has been triggered. If the user wishes to engage in the AR experience, the user selects an Allow button 304 on the AR enabled device 122. Permission access isn't always required. Permissions depend on the delivery medium (native vs web) and the AR enabled device 122.

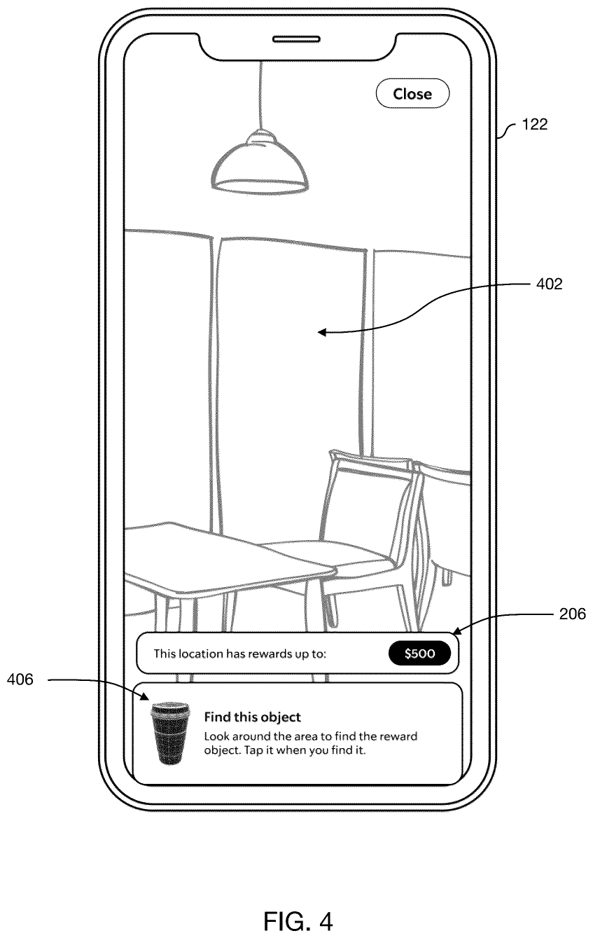

Referring to FIG. 4, the AR enabled device 122 is shown. The screen on the AR enabled device 122 follows after AR permissions are allowed (in FIG. 3). More specifically, the AR enabled device 122 shows the user a pass-through view 402 of the physical world around them-meaning the user will look through the device 122 and see an augmented version of the real world in front of their AR enabled device 122. Once in this view, the user will be prompted to look around and find a specific object-to-find. In addition to the pass-through view 402, the reward 206 is illustrated at the bottom to remind the user of the potential reward if they find the designated object. Also included on the screen of the AR enabled device 122 is an illustration of the object 406. This allows the user to have a visual representation of the object 406 located somewhere around them.

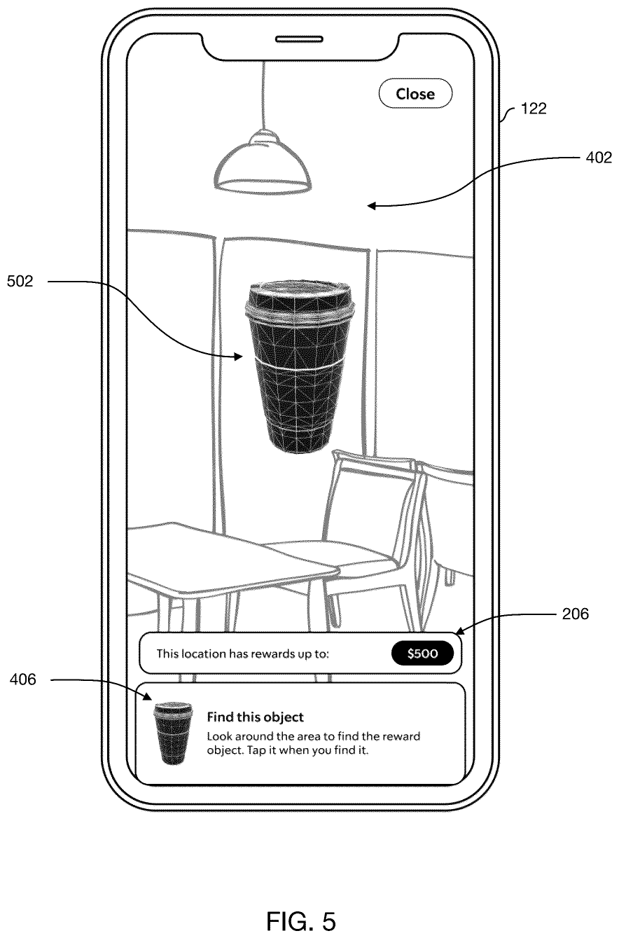

Referring to FIG. 5, the AR enabled device 122 is shown. The screen on the AR enabled device 122 still has the reward reminder 206, as well as the illustration of the object 406 that is to be located. In addition, within the pass thru screen 402 is a ‘virtual’ object 502. This is the object that the user is to find, as it is identical to the prompt 406. As the user looks around their physical environment (thru the AR enabled device 122), they will eventually discover the object to find positioned within or floating around the environment. Eventually, the user has located the object within the AR view 402 on the AR enabled device 122. At this point, the user taps (if the AR enabled device 122 is a phone or tablet), or gestures/looks at (in the case of a headset or other AR enabled device) the object to open it and receive the reward it represents. One skilled in the art will appreciate that alternatives methods may be used to indicate that the object has been found within the pass thru screen 402, whether such indication includes haptics, prompts, or software means which accurately concludes that the desired object 502 is within the pass thru screen 402, and has been recognized by the user. This invention should not be restricted to the methodology used to detect whether the user becomes aware of the ‘virtual’ location of the object 502 within the pass-thru screen 402.

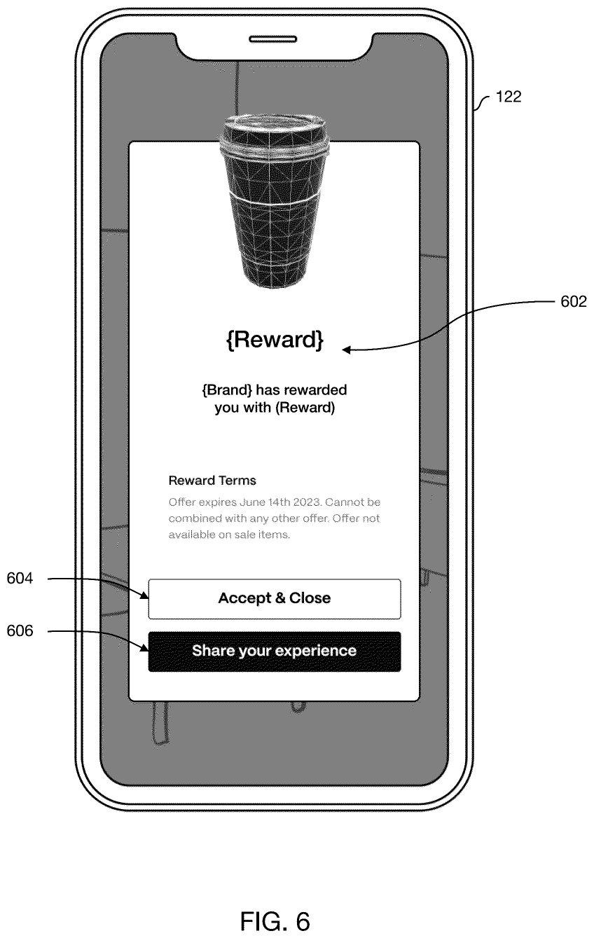

Referring to FIG. 6, once the AR enabled device 122 determines that the user has located the object to be found, the screen advances to what is shown in FIG. 6. At this point, the user is shown what Reward 602 they have one for locating the ‘virtual’ object. Examples of such Rewards could be monetary (e.g., $10), a discount, a promotion, a coupon, or physical items (e.g., a free latte, a gift card, or cash back), or points. Once the Reward 602 is indicated, the user can accept the Reward by pushing button 604, and/or share their AR reward experience with others by selecting button 606. The Reward is then placed into an account for the Brand that initiated the AR campaign. In one embodiment, acceptance of the Reward is not dependent on the press of the button 604. As soon as the user interacts with the object to find, the reward is associated with the user.

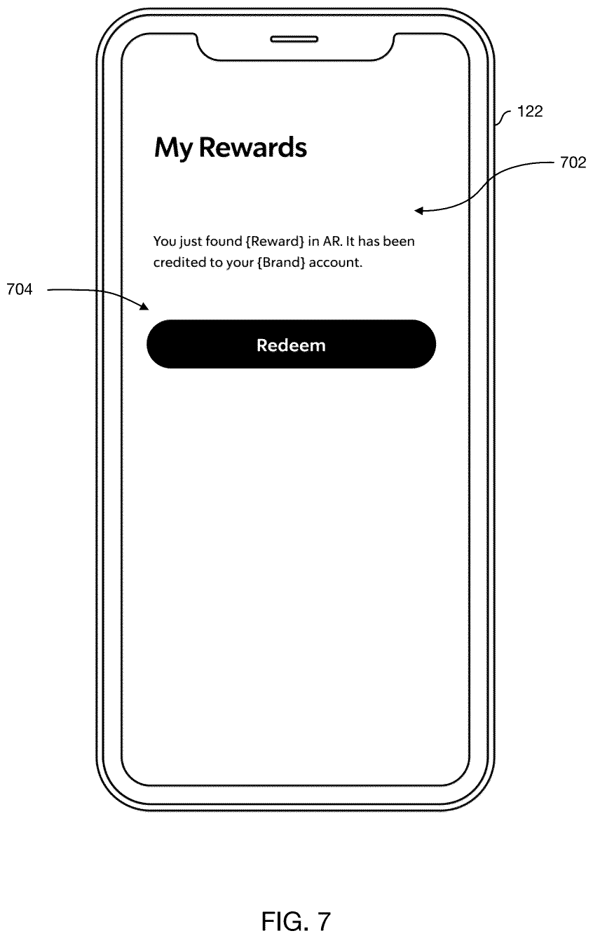

Referring to FIG. 7, the AR enabled device 122 is shown with a screen 702 that lists the Reward(s) that the user has won, within the AR experience. The user can choose to simply accumulate the rewards, or redeem any of the rewards, by selecting the Redeem button 704.

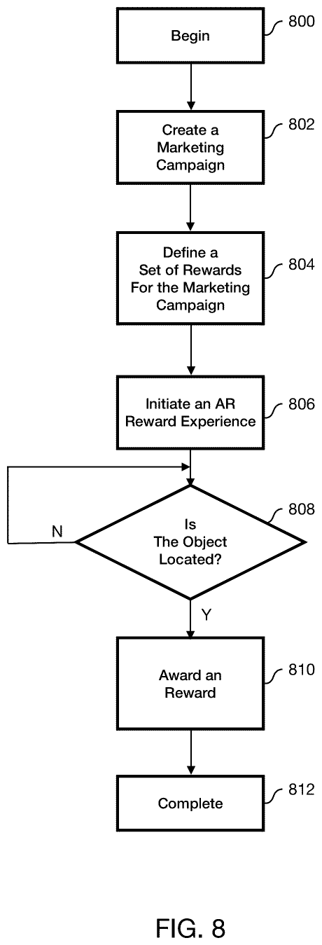

Referring to FIG. 8, a flow chart illustrating the method of the AR Reward Experience is shown. The experience begins at step 800 and flows to step 802. At step 802, a marketing campaign is created. A marketing campaign includes an AR Reward Experience utilizing an AR enabled devices such as a cell phone, tablet, watch, goggles, etc., as explained above. The marketing campaign operates via an application on such devices, or a web application operating on the devices. The marketing campaign creates objects that are recognizable within the view 402 described with reference to FIG. 5 and designates which of the created objects 502 will be shown within the view 402. The marketing campaign further defines the location of the objects 502. The location of the objects 502 may be placed either in a specific geo location, or alternatively, in a location relative to the geo location of the user (e.g., 5 feet away, 310 degrees, etc.).

Referring to step 804, a Set of Rewards for the Marketing Campaign are defined. The marketing campaign includes a number of possible rewards (i.e., % discounts, product giveaways, cash back bonuses) and designates one of the possible rewards for each AR Reward Experience. In one embodiment, the reward is chosen at the beginning of the AR Reward Experience. However, an alternative embodiment selects a Reward upon completion of the Reward Experience. The present invention should not be limited to the timing, or methodology used in selecting the Reward for a particular AR Reward Experience. What should be appreciated at this stage is that the AR Reward Experience is typically created by a business, or other retail entity that is wanting to attract consumers in an engaging way. It is the end user, or consumer that will have the AR Reward Experience that has been designed by a business or retail entity. Flow proceeds to step 806.

At step 806, the AR Reward Experience is initiated. Such initiation results in presenting the view shown with reference to FIG. 4. A thru screen view 402 is provided. Flow proceeds to step 808.

At step 808, the thru screen 402 continues to update based on where the AR enabled device 122 is pointing. As the user points the AR enabled device 122 to different areas within their location, the selected object 502 (of FIG. 5) will eventually show itself. The thru screen 402 continues to show a representation of the location until the selected object 502 appears. Once it is determined that the selected object 502 has been found, flow proceeds to step 810.

At step 810, a Reward that has been designated for the AR Reward Experience is presented to the user. The user can either redeem the reward, or save the reward for later redemption. Flow then proceeds to step 812 where the AR Reward Experience is completed.

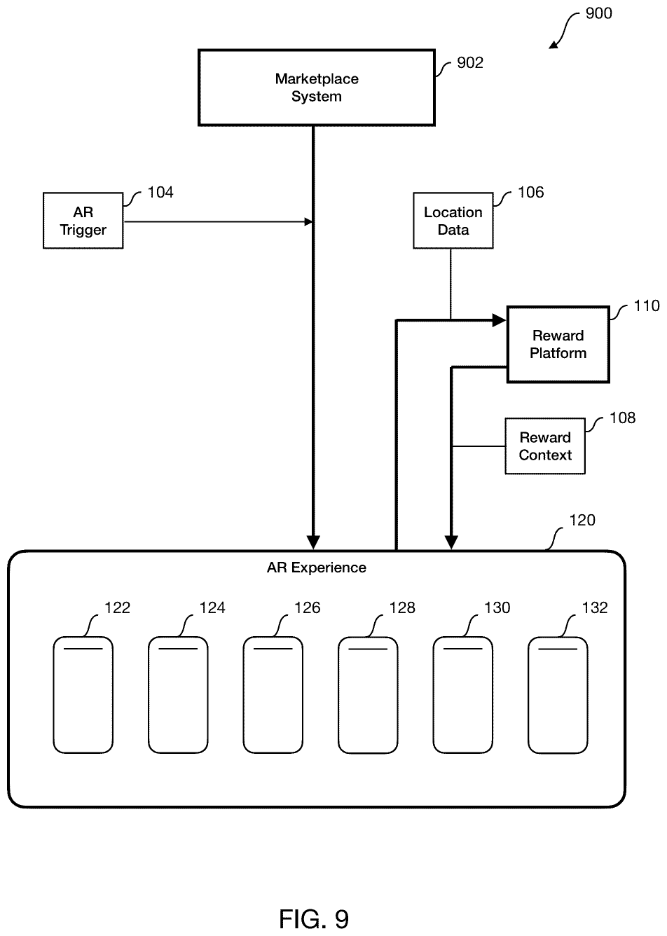

Referring now to FIG. 9, a variation of the invention illustrated in FIG. 1 is provided illustrating the workflow 900 for a post-transaction use case. In FIG. 9, the decision maker 102 is replaced by a marketplace system 902 that processes financial transactions. A qualifying transaction triggers the AR Reward Experience that is provided to the end user that just completed a transaction. Flow then proceeds as described above with respect to FIG. 1.

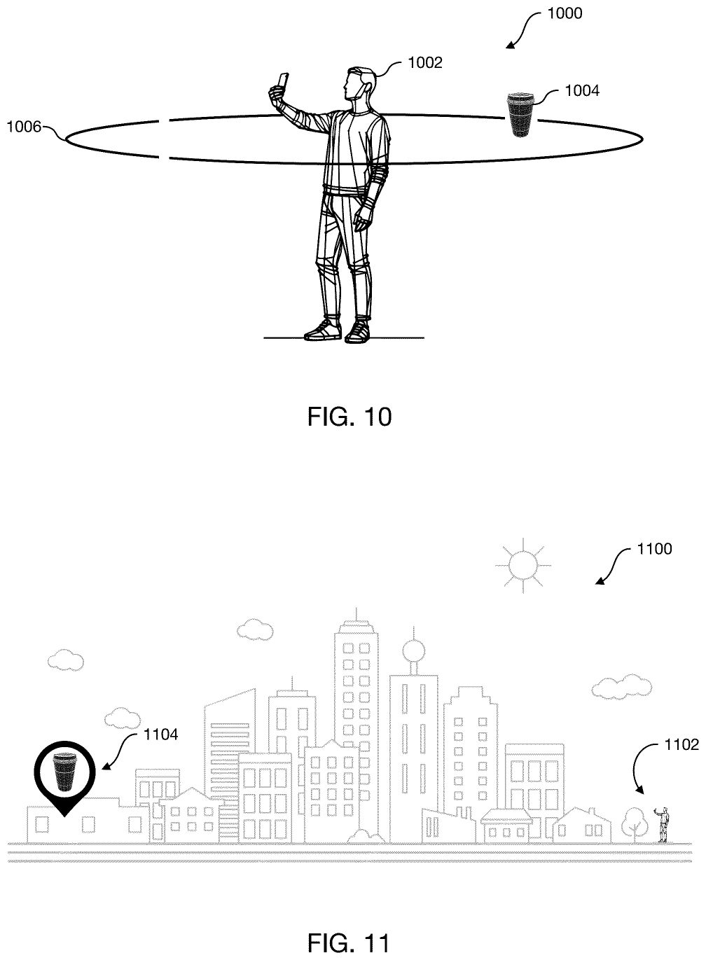

Referring to FIG. 10, an eligible end user 1002 is shown engaging in the AR Reward Experience. Upon entering the experience, the position of the object to find 1004 is randomly determined using a set of defined rules. In a defined rule set, there may be exclusion zones 1006 defined. Illustration 1000 shows a frontal exclusion zone 1006 of 70 degrees. This means that the object to find 1004 will not appear within 35 degrees to either the left or right of the center of the end users 1002 field of view when they enter the AR Reward Experience. Rather, the object 1004 is positioned randomly along a 360 degree arc, with the exception of the exclusion zone 1006 that is a fixed distance away from the end user 1002. In an alternative embodiment, there may be more than one exclusion zone 1006. One skilled in the art will appreciate that whether or not an exclusion zone 1006 is used, and the location/dimensions of the exclusion zone, can vary from one AR Reward Experience to another. It is up to the company owner, or retail space, to define the parameters of an exclusion zone 1006, as desired.

Referring to FIG. 11, a depiction 1100 is shown of how geo specific object positioning relative to the AR enabled device functions. More specifically, an eligible end user 1102 engages in the AR Reward Experience. Upon looking for the object to find 1104, the end user 1102 may or may not see the item based on their physical location. If they are too far away from the object, it will not be visible. The object to find 1104 shown is positioned at a specific location (geo coordinate). In one embodiment, the end user 1102 may be prompted with hints to help locate the specific location.

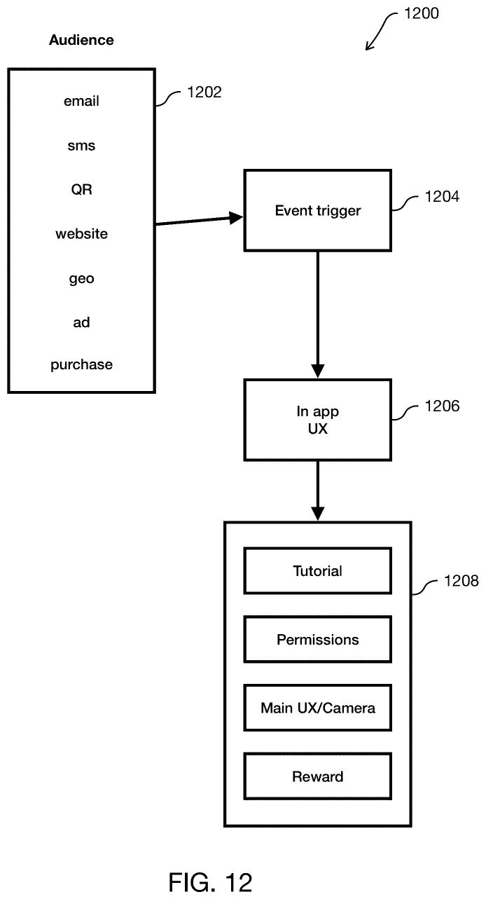

Referring to FIG. 12, a block diagram 1200 is shown illustrating how a user utilizing an AR enabled device is rewarded based on an event trigger. More specifically, a trigger may be initiated in many different ways. A block 1202 illustrates a few of the ways for an AR experience to trigger. The block includes: email, sms, QR codes, websites, geo fence initiated, or advertisements.

If a marketer wishes to initiate an email campaign, emails are sent to a preselected audience. The preselected audience may be an existing customer base. Or, it may be a group of emails developed to target a specific audience. In either case, emails are sent to users with a built in prompt to initiate an AR experience. In one embodiment, the prompt is to download a program to allow an AR experience on the users device.

Similarly to email, a marketer may utilize text messaging (sms) to a select group of one or more people in an audience. Again, the preselected audience may be an existing customer base. Or, it may be a group of telephone numbers developed for target a specific audience. In either case, texts are sent to users with a prompt to download a program to allow an AR experience on the users device.

In the above two instances, a marketer has initiated the manner of delivering an AR experience to the audience. In some instances a user may initiate the AR experience themselves. They may see an ad (advertisement) on a website, or view a QR code on a website or on social media, or even in a retail store. If they engage with the ad, QR code or website, they will be taken to a location to download an application file to allow the AR experience.

Additionally, a user may engage in activity that initiates the event trigger. For example, if the user is inside a retail space that is utilizing the AR experience according to the present invention, they may use their cell phone, smart watch or tablet device to pay for a purchase. When this occurs, the retail space may send a trigger to the cell phone, smart watch, or tablet device to initiate the AR experience.

Furthermore, a geofence may be used by a retailer, within the boundaries of their retail space, or even within a predefined geographic area (such as a pop up tent at a concert, convention, etc.). The geofence utilizes location aware devices, such as cell phones, smart watches, tablets, etc.) to determine which devices enter or leave a particular geofence. One skilled in the art will appreciate that within a particular geofence, sub geo fences may exist. For example, if the retail space was a Target store, sub geo fences may include a grocery department, a clothing department, a home decor department, etc. When the retailer determines that a user (or their location aware device) has entered or exited a particular geofence, an event trigger may be initiated to that device to initiate an AR experience.

Any of the instances described above with respect to block 1202 creates an event trigger 1204. The event trigger occurs within a device such as a cell phone, tablet, smart watch, laptop computer, etc. The event trigger produces a prompt on the device which a user may ignore, cancel, or approve. If the user approves, an application program (or plug-in) may be loaded on to their device. Flow then proceeds to block 1206.

At block 1206, the AR application program is loaded onto the device, and launched. Flow proceeds to block 1208.

At block 1208, the AR application presents a tutorial on the device to the user. The tutorial has been described above with reference to FIGS. 2-7. After the tutorial, permissions need to be allowed, as discussed above with reference to FIG. 3. If permissions are granted, the main program begins, utilizing the device and its built in camera, as described above with reference to FIGS. 4-7.

What should be appreciated in particular, with respect to FIG. 12, is that any number of event triggers may initiate the AR experience according to the present invention. Some of these triggers are created by the marketer for the retailer. Others are initiated by the user, either thru a purchase, or scanning a QR code, or from a website. And, others are initiated based on the location of the user (or their device) within a geofence. In any of these instances, the AR experience is the same, regardless of which event triggered the initiation of the experience.

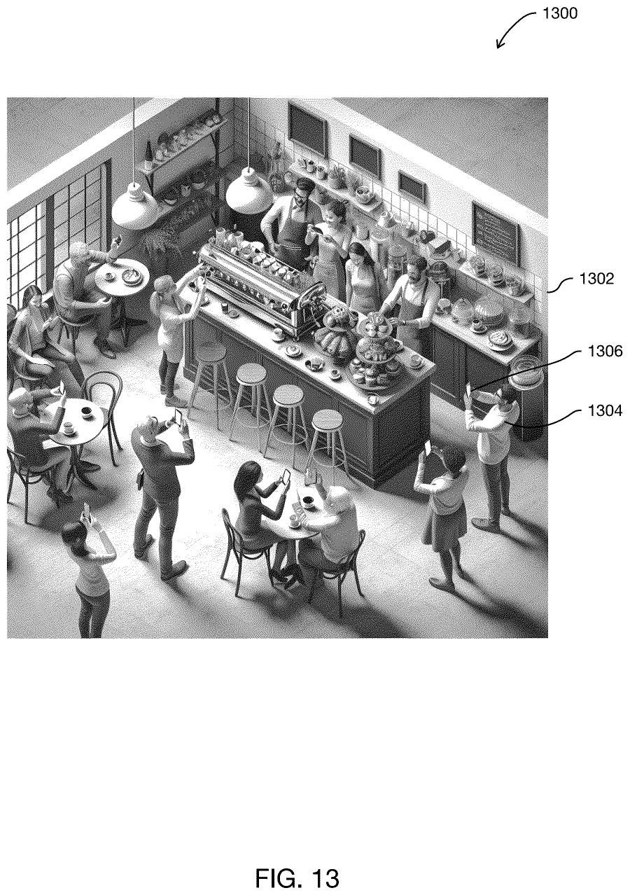

Referring to FIG. 13, a pictorial drawing 1300 of a coffee shop 1302 is shown. Inside the coffee shop 1302 are a number of patrons 1304. In one embodiment, each of the patrons 1304 is engaging in the AR Reward experience according to the present invention. Each of the patrons 1304 has an AR enabled device 1306, which in this illustration, is a smart phone. However, as mentioned above, one skilled in the art will appreciate that any AR enabled device (i.e., smartphone, tablet, goggles, etc.) could be used to engage in the AR Reward experience. It should also be appreciated, as above, that the patrons 1304 may each be participating in the AR Reward experience, as individuals. But, in one embodiment of the present invention, groups of patrons may participate together in a group competition AR Reward experience.

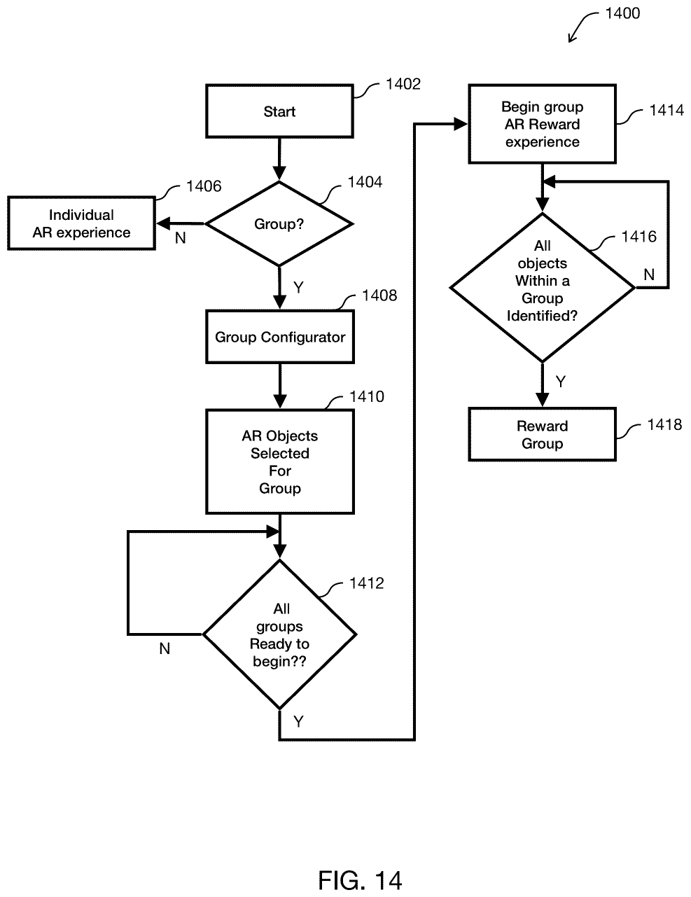

Referring to FIG. 14, a block diagram 1400 is shown of a flow chart illustrating how a group competition AR Reward experience would flow. Beginning at block 1402, flow proceeds to decision block 1404.

At decision block 1404, a determination is made as to whether an individual is wishing to join a group for a competition AR Reward experience, or alternatively, proceed as an individual with our own AR Reward experience. If they wish to proceed alone, flow proceeds to block 1406. At block 1406, progression thru the AR Reward Experience is similar to what has been described above with reference to FIGS. 3-7. If however, the user/patron wishes to participate in a group experience, flow proceeds to block 1408.

At block 1408 a group configurator is used to establish groups for the group competition. In one embodiment, the group configurator is part of the AR reward system, and operates in the cloud, and is specific for a particular AR reward experience within a specified physical space. The users are provided the opportunity to select which group they would like to join. Alternatively, a group is automatically assigned to the patron. One skilled in the art should appreciate that the number of groups that are allowed to participate in a competition may vary from retail space to retail space. Also the number of people that can participate together within a group may vary. Both the number of groups that are allowed to participate within a particular reward experience, as well as the number of people that are allowed to join a group are variables within the control of the marketer or the retail space. once a group is chosen, flow proceeds to block 1410.

At block 1410 the AR system selects the AR objects that will be presented to each patron in the group. if multiple groups are competing against each other, they may either be presented with the same objects in the same virtual location, or each group may be proceeded with an equivalent number of objects, but the object objects may be different. Once all the groups are ready to compete flow proceeds to block 1414.

At block 1414 each group begins identifying the objects. Flow then proceeds to decision block 1416.

Decision block 1416 continues to monitor the identification of the objects for each group. In one embodiment, the objects are presented in a single instance within the retail space to allow any member of the group to find and select the object. Once a member of the group finds and identifies the object, it is marked as identified within the system, and the group members are told to find the next object. In an alternative embodiment, all of the objects that must be found are presented to the group so that they can identify the object objects as they see them through their AR enabled device. Once all of the objects that are presented are identified by a group, the competition ends for that group. It should be appreciated that when multiple groups are competing against each other, the group that finds all of the objects the fastest wins. Once a group identifies all of the objects, flow proceeds to block 1418.

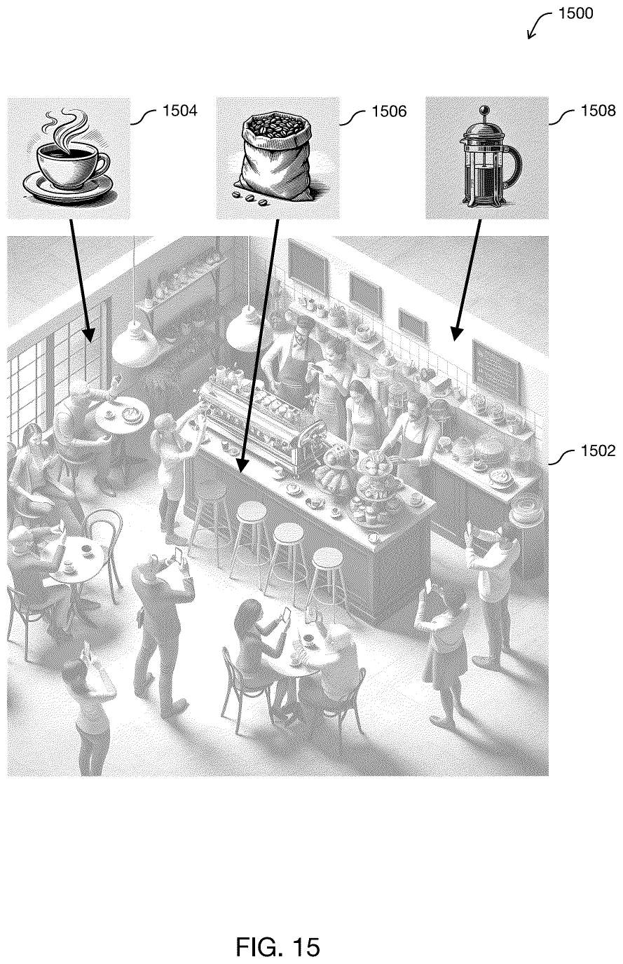

It should be appreciated that if there are a limited number of groups, and/or the number of participants in each group are small, there may be just one reward per group, or one reward for each member of the group, however, as the number of participants per group increases, or the number of groups increase with a competition, it is possible for more than one group to win an award. For example, the winning group would win a first place reward. The group coming in second would win a second Pl. reward, etc. All variables associated with the number of rewards available, the number of AR objects to be identified, the number of participants within a group, and the number of groups allowed to compete, are variables that can be controlled by the developer of the present invention, and made available to marketers and/or retailers who utilize the AR Reward experience system. To better illustrate what has been described above with reference to FIG. 14, attention is now directed to FIG. 15.

In FIG. 15, the coffee shop of FIG. 13 is illustrated as image 1502. Also shown are a plurality of objects to be found/identified within the AR Reward Experience. In one embodiment, since the retail space is a coffee shop, the objects to be identified are a coffee cup 1504, a bag of coffee 1506, and a French press 1508. These objects are virtually placed within the physical coffee shop 1502, for identification by the patrons. In one embodiment, the objects are placed in the same virtual location, regardless of how many participants are within a group, or how many groups are competing. The group AR Reward experience then proceeds similarly to what was described above with reference to FIG. 14.

It should be appreciated that the retail space described above is for illustration purposes only. A marketer may choose a substantially larger space, such as a Walmart super store, an even larger space such as an event center or concert venue, or any space where objects may be virtually placed. The location, style of space, or size of space, are simply variables that can easily be accommodated by a marketer when utilizing the AR Reward experience of the present invention.

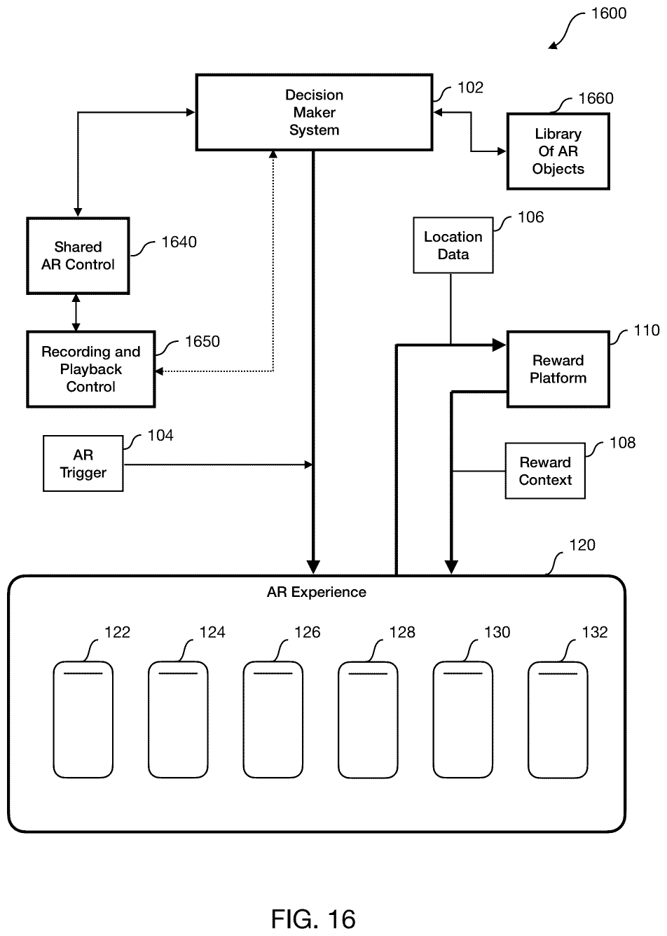

Referring now to FIG. 16, a block diagram 1600 of the system described above with respect to FIGS. 1-8 is shown. What is added is a Shared AR Control 1640 to allow the Shareable AR Experience as has been described above with respect to FIGS. 13-15. A Shareable AR control 1640 is in communication with the Decision Maker System 102. The Shareable AR control handles the shared group AR experience described above.

In addition to block 1640, the present invention includes Recording and Playback Control 1650. In one embodiment, the recording and payback control 1650 is in communication with the Shared AR control 1640 for recording and playing back video of group play of the AR Reward Experience as described above with reference to FIGS. 13-15. For example, as each of the participants of a group AR experience use their AR enabled devices to locate and identify virtual objects within their surrounding physical space, their AR enabled devices record their experience, and communicate their experience back to the system 1600, particularly the Recording and Playback control 1650, which stores their experience. Participants can then selectively view their own experience, or another user within their group, or even users within other groups, depending on the accessibility provided by the Decision Maker System 102.

In an alternative embodiment, the Recording and Playback control 1650 is also in communication with the Decision Maker System 102 so that any individual user can record and play back their own participation within the AR Reward experience.

In a further embodiment, the AR reward experience can simply allow the AR enabled device to record the view of the AR enabled device during the AR experience, using the devices built in recording capabilities, similar to recording a video. However, it records all aspects of the AR experience, including the AR items placed within the physical space during participation. The user can then replay their activity from within their own video library on their AR enabled device. Regardless of whether the ‘video’ of the AR experience is recorded on the AR enabled to device, or in the recording and playback control 1650, what is important is that the AR experience is recorded, and available for playback.

Still referring to FIG. 16, a Library of AR Objects 1660 is found. The Library of AR objects is provided for merchants to be able to select from a catalog of objects, those that are most relevant to their store. This is particularly illustrated with reference to FIG. 15, where 3 objects 1504, 1506, and 1508 are shown, which are inserted into the AR experience within a coffee shop 1502. However, the present invention is provided to merchants with a plurality of AR objects that may be selected, depending on the market that the merchant is within, whether coffee shop, restaurant, sports bar, grocery, clothing, etc. Furthermore, the present invention is capable of allowing merchants to create their own objects, either through photographs, images, or drawing programs, to import into the Library 1660, and/or as 3D objects within the AR experience.

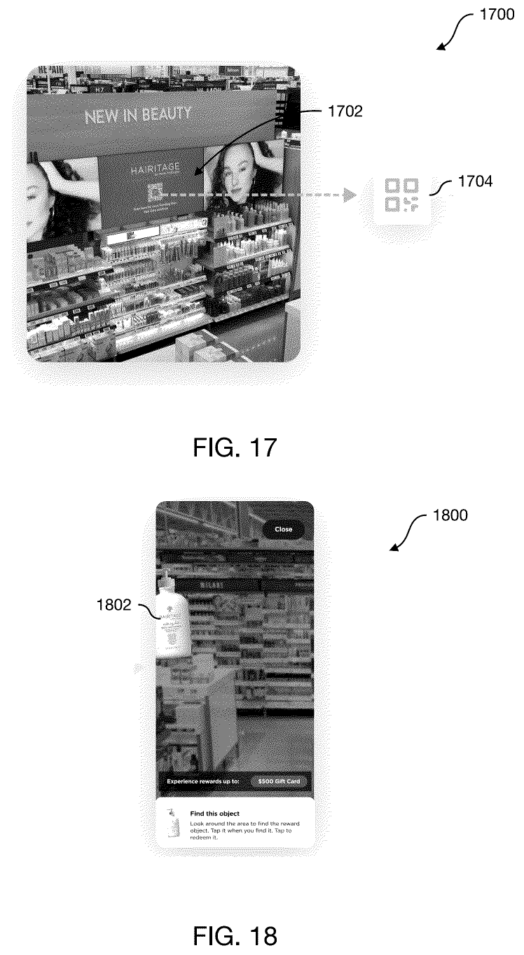

Referring now to FIG. 17, an in store media network display 1700 is shown. The display includes a digital display 1702 that is advertising a particular product. The advertising utilizes a QR code 1704. In one embodiment, the QR code 1704 acts as a prompt to encourage a customer to scan the code. Scanning of the QR code 1704 acts as an event trigger to take the customer into an AR reward experience. Alternatively, utilizing geo fence technology, an event trigger may occur on the customer AR enabled device when the customer approaches the designated area of the store defined by the geo fence. In either case, the customer's AR enabled device is triggered.

Referring now to FIG. 18, an AR experience view 1800 is shown on the customer's AR enabled device. After scanning the QR code 1704, the customer is viewing the screen 1800. Upon finding an AR object 1802 (correlating to the product being advertised), the customer is presented with a reward relevant to the shelf display items and the colocated digital display they just scanned. In one embodiment, the digital display is proximate to the product being advertised. In an alternative embodiment, the digital display may be in another part of the retail space, and may be used to guide the user to a particular part of the store. In either case, once the customer locates the advertised AR object 1802, a reward screen is shown.

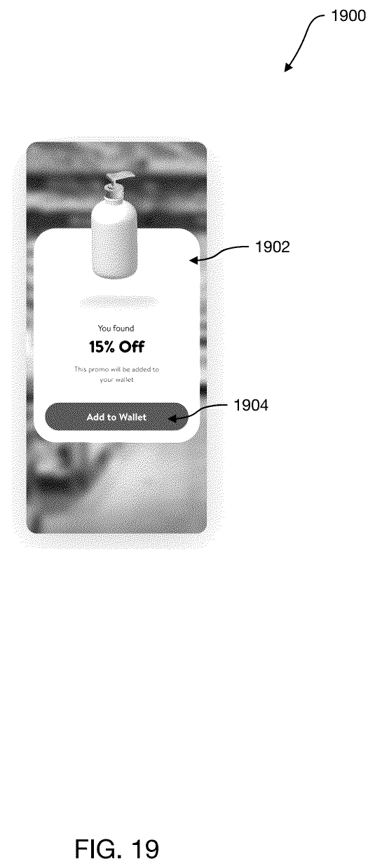

Referring now to FIG. 19, a reward screen 1900 is shown. More specifically, a reward 1902 is shown providing an AR reward 1902 correlating to the AR object 1802 that was located by the customer. In this instance, the reward is a % discount off the retail price of the product. It should be appreciated, that the reward could be any form of monetary reward, either a % discount, a specific $ off amount, or other rewards specified by the retail merchant. To accept the reward, the customer should select the “add to wallet” button 1904 on the screen of their AR enabled device. The customer now has the reward, and can place the item in their basket and head to checkout. Once the customer purchases the item, the merchant receives sales attributed to their investment in the digital display setups throughout the store.

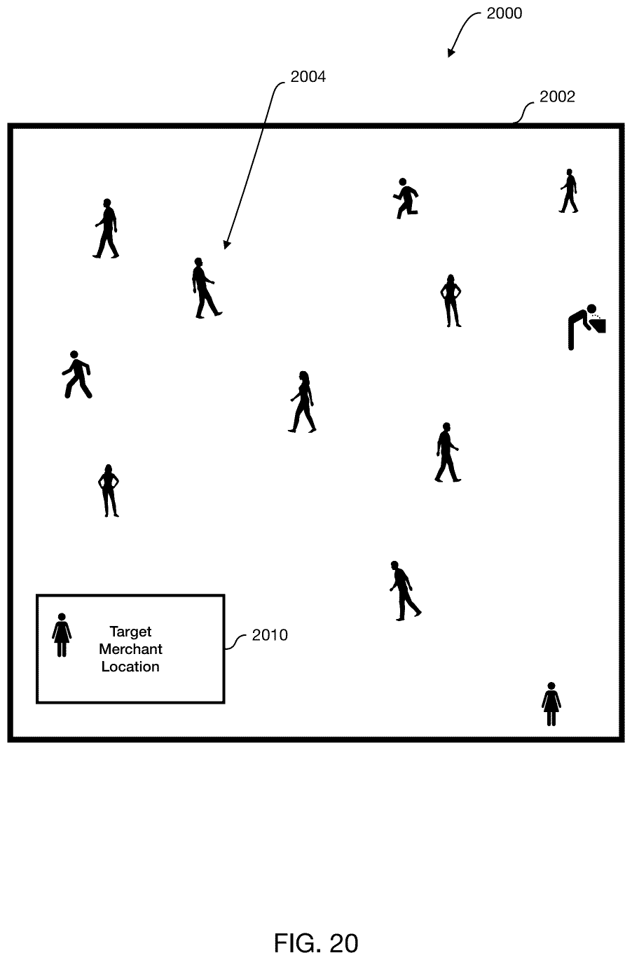

Referring now to FIG. 20, an event space 2002 is shown. The event space 2002 may be a concert venue, an auto show, or a retail space. The size of the event space is irrelevant to the present invention. The event space 2002 includes a plurality of attendees 2004. Any of the attendees 2004 that are carrying a device capable of being AR enabled, as described above, can also receive an event trigger to enable their AR device, once they are within the geo fence within the event space 2002. In one aspect of the present invention, a merchant may wish to drive some or all of the patrons within the geofence towards, and into, their location 2010. An example of such would be a credit card merchant. They may have purchased space at an outdoor event space, such as a concert. They may have set up an air conditioned tent and wish to appeal to potential customers to get them to sign up for credit card services. The credit card merchant would set up an event trigger to any customer within the event space that has a device capable of being AR enabled. If the customer accepts the event trigger, they can then scan the area around them, as part of the AR reward experience, and look for an AR object. In one embodiment, the AR object may be a tent, which when find, will guide the customer in the general direction of the target merchant location 2010. The AR object might also, in the example of a credit card merchant, be a 3D rendering of their credit card. Regardless of the type of object shown, the purpose of the AR object on the AR enabled device is to guide the customer towards the target merchant location.

Furthermore, the target merchant location 2010 is aware of any customer that enters their specific geo fence. The merchant can then provide an AR reward to the customer, once they enter the geo fence within the merchant location 2010. An example of an AR reward, for the credit card merchant, could be 6 months free interest on any credit card transfers. The customer can then accept the reward and sign up for the credit card within the merchant location 2010.

What has just been described with reference to FIG. 20 is just one example of utilizing geo fence technology with cell or wifi devices that may be AR enabled. What should be appreciated is that geo fences may be used within the AR Reward experience as described above, to create event triggers to attract customers to particular merchant locations. Other implementations of geo fence technologies in conjunction with devices that may be AR enabled are within the scope of the present invention.

What has been described above, and in the drawings and appended claims, is a method and apparatus for providing an end user with an engaging and rewarding Augmented Reality (AR) experience designed to both entertain and reward the end user in a particular product or market.

It should be understood—especially by those having ordinary skill in the art with the benefit of this disclosure—that the various operations described herein, particularly in connection with the figures, may be implemented by other hardware components utilizing telecommunications, whether towers, satellites, or wifi. Additionally, the order in which each operation of a given method is performed may be changed, unless otherwise indicated, and various elements of the systems illustrated herein may be added, reordered, combined, omitted, modified, etc. It is intended that this disclosure embrace all such modifications and changes, and, accordingly, the above description should be regarded in an illustrative rather than a restrictive sense.

Similarly, although this disclosure refers to specific embodiments, certain modifications and changes can be made to those embodiments without departing from the scope and coverage of this disclosure. Moreover, any benefits, advantages, or solutions to problems that are described herein with regard to specific embodiments are not intended to be construed as a critical, required, or essential feature or element.

Further embodiments, likewise, with the benefit of this disclosure, will be apparent to those having ordinary skill in the art, and such embodiments should be deemed as being encompassed herein. All examples and conditional language recited herein are intended for pedagogical objects to aid the reader in understanding the disclosure and the concepts contributed by the inventor to furthering the art and are construed as being without limitation to such specifically recited examples and conditions.

1. An Event Triggered Augmented Reality (AR) Reward Experience system, comprising:
An AR device;
An AR Event Trigger, in communication with the AR device, for initiating an AR Reward Experience; and
A Reward system, in communication with the AR device, for communicating a Reward to the AR device;
wherein the AR Reward Experience system provides an engaging augmented reality for allowing a user to recognize a virtual object using their AR enabled device, for the purpose of earning a reward; and
wherein the AR Reward Experience is initiated by an AR Event Trigger.

2. The AR Reward Experience system of claim 1, wherein the AR enabled device comprises:
a cell phone;
a tablet; or
AR goggles.

3. The AR Reward Experience system of claim 1 wherein the Event Trigger comprises:
a communication from the AR Reward Experience system to the AR enabled device.

4. The AR Reward Experience system of claim 3 wherein the communication is an email.

5. The AR Reward Experience system of claim 3 wherein the communication is an SMS message.

6. The AR Reward Experience system of claim 3 wherein the communication results from scanning a QR code.

7. The AR Reward Experience system of claim 3 wherein the communication results from entering a geofence.

8. The AR Reward Experience system of claim 3 wherein the communication results from a retail space that has the AR Reward Experience.

9. The AR Reward Experience system of claim 3 wherein the Second Software comprises an application on an AR enabled device.

10. The AR Reward Experience system of claim 3 further comprising:
a Reward Platform, coupled to the Decision Maker System, for creating rewards for the AR Reward Experience.

11. The AR Reward Experience system of claim 10, wherein a Reward Platform comprises:
an interface for creating a plurality of Rewards for a particular campaign; and
a database for storing each of the plurality of Rewards for the particular campaign.

12. A marketplace system for providing an Event Trigger to an AR enabled device, comprising:
an Event Trigger, for triggering an AR enabled device;
the AR enabled device, for receiving the trigger; and
software, executing on the AR enabled device, for launching an AR Reward Experience, wherein the software:
provides a thru view of the world in front of the AR enabled device;
presents a selected object to the end user when the AR enabled device is pointed at a preselected virtual position relative to the end user; and
presents a Reward to the end user when the end user locates the selected object within the thru view;
wherein the end user is engaged in the AR Reward Experience after receiving the Event Trigger.

13. A marketing method for engaging a user in a marketing campaign, the marketing campaign utilizing an Augmented Reality (AR) system, the method comprising:
creating a marketing campaign within the AR system;
defining a set of rewards within the marketing campaign, the rewards selected for users that complete the marketing campaign;
initiating an AR Reward Experience utilizing an event trigger; and
Upon completion of the AR Reward Experience, awarding a reward from the set of rewards to an end user that completes the marketing campaign;
wherein the marketing campaign engages the end user utilizing the AR system, thereby creating an effective marketing campaign.

14. The marketing method as recited in claim 13 wherein the step of creating comprises:
creating a plurality of objects to be utilized within the AR Reward Experience, the objects selected for display overlays on a thru screen to an AR enabled device; and
defining a location for the display overlays that are relative to the AR enabled device for display on the thru screen of the AR enabled device.

15. The marketing method as recited in claim 14 wherein the step of defining a location for the display overlays, places the display overlays in a specific geo location, for identifying on the thru screen of the AR enabled device.

16. The marketing method as recited in claim 13 wherein the step of defining comprises establishing a percentage discount to be applied on a purchase.

17. The marketing method as recited in claim 13 wherein the step of defining comprises establishing a percentage discount to be applied to a purchase of a pre selected item.

18. The marketing method of claim 13 wherein the step of defining comprises establishing a gift for the end user.

19. The marketing method as recited in claim 13 wherein the step of Initiating an AR Reward Experience comprises:
sending a trigger to an AR enabled device;
specifying a selected object to be shown to the end user; and
specifying a reward to be provided when the end user locates the selected object on the AR enabled device.

20. An Augmented Reality (AR) Reward Experience system, comprising:
an AR enabled device;
A Decision Maker System, in communication with the AR enabled device, the Decision Maker System configured to create a Reward Campaign for at least one AR enabled device; wherein the Decision Maker system utilizes an Event Trigger to initiate the AR Reward Experience with the AR enabled device; and
A Reward Platform, in communication with the Decision Maker System and the AR enabled device, for communicating a Reward to the AR enabled device;
wherein the AR Reward Experience system provides an engaging augmented reality for allowing a user to recognize a virtual object overlayed in a physical location using their AR enabled device, for the purpose of earning a monetary reward.

21. The Augmented Reality Reward Experience of claim 20, wherein the Event Trigger is sent to the AR enabled device via email.

22. The Augmented Reality Reward Experience of claim 20, wherein the Event Trigger is sent to the AR enabled device via an SMS message.

23. The Augmented Reality Reward Experience of claim 20, wherein the Event Trigger is sent to the AR enabled device when the AR enabled device enters a geofence.
